(19) United States
(12) Patent Application Publication
(10) Pub. No.: US 2025/0346006 A1
(43) Pub. Date: Nov. 13, 2025

(54) INTEGRATED INJECTION-MOLDING METHOD FOR LENS, AND LENS FORMED BY INTEGRATED INJECTION-MOLDING METHOD

(71) Applicant: Shenzhen Linktop IOT Co., Ltd, Shenzhen (CN)

(72) Inventor: Peipei Hu, Shenzhen (CN)

(21) Appl. No.: 19/278,570

(22) Filed: Jul. 23, 2025

(51) Int. Cl. B29D 11/00; B29C 45/00; B29C 45/73; B29C 45/74; B29C 45/76; B29C 45/77; B29C 45/78; B29K 69/00; B29L 11/00

(52) U.S. Cl. CPC B29D 11/00432; B29C 45/0001; B29C 45/73; B29C 45/74; B29C 45/762; B29C 45/77; B29C 45/78; B29C 2045/0058; B29C 2045/0077; B29C 2945/76153; B29C 2945/76431; B29C 2945/76498; B29C 2945/76531; B29C 2945/76561; B29C 2945/76668; B29C 2945/76806; B29K 2069/00; B29K 2995/0026; B29K 2995/0077; B29K 2995/0093; B29L 2011/0016

(57) ABSTRACT

The invention belongs to the technical field of integrated machining of lenses and provides an integrated injection-molding method for a lens and a lens formed by the integrated injection-molding method to overcome the defect of poor sealing performance of lenses in the prior art caused by separate assembly of the lenses during production. In the invention, a high-transparency polycarbonate material is purified to remove impurities and moisture; then, an integrated mold is debugged; a material plasticization and filling process, a temperature holding process and a cooling process are accurately controlled by means of an injection molding machine to realize integrated formation of a lens and a product body; and after being formed, the product body is processed, and performance is detected. In this way, the sealing performance of the lens is improved.

### BACKGROUND OF THE INVENTION

### Technical Field

The invention relates to the technical field of integrated machining of lenses, in particular to an integrated injection-molding method for a lens, and a lens formed by the integrated injection-molding method.

### Description of Related Art

Integrated machining of lenses refers to the integration of multiple production steps, such as grinding, polishing and coating, of the lenses into a continuous and automatic process by means of an advanced technology to realize high-precision, high-efficiency and low-cost mass production of the lenses and may significantly improve the quality stability and production efficiency of the lenses.

Chinese Patent Publication No. CN114815013B discloses a machining method for a flat lens, including: fixing a substrate on a stationary base; covering an upper surface of the substrate with a printing plate; pouring ink onto the printing plate; scraping an upper surface of the printing plate by means of a scraper; and removing the scraper and the printing plate from the upper surface of the substrate to allow ink corresponding to each mesh of the printing plate to be left on the substrate, and curing the ink to form spacers; wherein, the viscosity of the ink before curing is 5000-30000 cps, and the shore hardness of the spacers formed after curing is 70 A-90 D. In this way, the forming efficiency of the spacers is greatly improved, and the height, shape, spacing and other parameters of the spacers are maintained.

In the implementation of the above patent, the lens is generally machined separately, and multiple components that are machined separately, such as the lens, a lens mount and a sealing gasket need to be assembled Because of the deviation in production accuracy of the components and the dependence of the assembly process on manual operation, absolutely close fit between the components cannot be guaranteed in the assembly process; and even if auxiliary materials such as sealants are adopted, joints crack easily due to thermal expansion and contraction, vibrations and other factors in long-term use, leading to poor sealing performance.

In view of this, an integrated injection-molding method for a lens, and a lens formed by the integrated injection-molding method are provided.

### BRIEF SUMMARY OF THE INVENTION

The technical issue to be settled by the invention is to overcome the defects in the prior art by providing an integrated injection-molding method for a lens and a lens formed by the integrated injection-molding method, which solve the problem of poor sealing performance of lenses in the prior art caused by separate assembly of the lenses during production.

To settle the above technical issue, a technical solution adopted by the invention is as follows: an integrated injection-molding method for a lens includes the following steps:
S1: first, selecting a high-transparency polycarbonate material, and purifying the high-transparency polycarbonate material to remove impurities and excess moisture so as to improve material purity to ensure that the high-transparency polycarbonate material satisfies material quality requirements of injection molding;
S2: performing comprehensive inspection and debugging on a manufactured integrated hardware injection mold, and paying close attention to a mold temperature control system and a mold cooling system to ensure that all components of the mold are installed accurately and in a good operating condition and satisfy injection-molding process requirements;
S3, feeding the processed polycarbonate material into a barrel of an injection molding machine, and controlling temperature, pressure and time parameters of the injection molding machine to complete filling, compaction and cooling of the material in a mold cavity so as to realize integrated formation of a lens and other structures to guarantee structural compactness and waterproofness of a product body;
S4: when the product body is formed gradually, ejecting an injection-molded lens product from the mold, removing flash and burrs on surfaces of the lens product, and finishing the lens product by sanding and polishing according to a product quality standard to improve product appearance and surface quality; and
S5, when the product body is taken out, comprehensively detecting size accuracy, optical properties, waterproofness and structural strength of the lens product by means of multiple professional detection methods, and determining whether the product body is qualified according to the strict quality standard to ensure that the product body flowing into the market has a reliable quality.

Further, in a step of injection molding material processing in S1, the polycarbonate material is placed in a hot-air circulation drying device, a drying temperature is controlled to 120° C.-130° C., and the polycarbonate material is continuously dried for 4-6 hrs until a moisture content of the polycarbonate material is decreased to be less than 0.02%, to avoid bubbles and silver streaks caused by moisture in the injection molding process.

Further, in a step of mold debugging before injection molding in S2, the mold temperature control system is accurately controlled to maintain a temperature in the mold cavity at 80° C.-90° C. to guarantee smooth flowing and filling of the material in the mold cavity, and at the same time, a flow rate of cooling water in the mold cooling system is controlled to 1 m/s-2 m/s to guarantee uniform and efficient cooling of the mold.

Further, in the step of mold debugging before injection molding in S2, sealing performance of an overall structure of the mold is detected by applying compressed air at a pressure of 0.5 MPa-0.8 MPa into the mold cavity by means of an air pressure leakage-detection device, holding the pressure for 5-10 min and monitoring that a pressure drop is not over 0.05 MPa, or by smearing soapy water at joints of the mold and observing that no bubble is generated within 30 s, to ensure that no gas leaks from the mold in the injection molding process.

Further, in a step of integrated injection-molding in S3, a temperature of a feeding section of the barrel of the injection molding machine is set to 220° C.-240° C., a temperature of a compression section is set to 240° C.-260° C., and a temperature of a metering section is set to 260° C.-280° C., to guarantee full plasticization of the material; and an injection-molding pressure is set to 80 MPa-120 MPa, an injection-molding time is controlled to 10 s-30 s, a holding pressure is set to 60 MPa-90 MPa, and a holding time is controlled 5 s-15 s, to guarantee dense filling of the material in the mold to avoid shrinkage and incomplete filling of a product.

Further, in the step of integrated injection-molding in S3, the mold cooling system is started instantly after injection-molding filling is completed; a flow rate and temperature of a cooling medium are controlled to realize quick and uniform cooling of the product body, wherein the cooling medium is cooling water, and the temperature of the cooling water is maintained at 15° C.-25° C.; in a case where the product body has a small wall thickness, a cooling time is 10 s-20 s; in a case where the product body has a large wall thickness, the cooling time is 30 s-60 s, such that deformation and warping of the product body caused by nonuniform cooling are avoided to guarantee size accuracy and appearance quality of the product body.

Further, in a step of post-processing the formed product body in S4, an environmentally-friendly release agent is used for demolding to reduce friction between the product body and the mold so as to ensure that the product body is smoothly ejected from the mold and surfaces of the product body are not damaged; after demolding, the flash and burrs on the surfaces of the product body are removed with a special tool; portions with a high precision requirement are sanded by means of a numerically-controlled sanding device with a sandpaper, a granularity of which sequentially decreases from 80 meshes, 120 meshes, 240 meshes to 400 meshes; and finally, the product body is polished by means of a polishing machine and a polishing paste until surface roughness of the product body reaches Ra0.2-Ra0.4 μm, such that the appearance quality of the product body is improved.

Further, in a step of quality detection and evaluation of the product body in S5, a light transmittance, a refractive index and a chromatic dispersion of the product body are tested by means of an optical tester; as required, the light transmittance is not less than 88% and the refractive index is in line with a design value ±0.002, to ensure that the optical properties of the product body are up to standard; and whether the waterproofness of the product body satisfies use requirements is verified by means of a waterproof test device according to a criterion that no water leaks from the product body after the product body is maintained at a pressure of 10 kPa for 30 min.

Further, in the step of quality detection and evaluation of the product body in S5, an anti-aging performance test is performed on the product body; the product body is placed in an environmental test chamber at a temperature of 70° C. and a humidity of 90%, and after the product body is retained in the environmental test chamber for 1000 hrs, changes of optical and mechanical properties of the product body are detected; and whether the product body has good anti-aging performance and durability to adapt to different service environments is verified according to a criterion that a decrease in light transmittance is not over 5% and a decrease in tensile strength is not over 10%.

Further, a lens is fixedly mounted in the product body, a shell is arranged on a lower surface of the product body, a lamp holder is fixedly mounted in the shell, and the lamp holder and the lens are located on a same vertical line.

Compared with the prior art, the invention has the following beneficial effects:

According to the integrated injection-molding method for a lens and the lens formed by the integrated injection-molding method, when a lens is produced, first, a high-transparency polycarbonate material is selected and dried by hot-air circulation at a temperature of 120° C.-130° C. for 4-6 hrs until the moisture content of the polycarbonate material is less than 0.02%, thus improving the purity of the polycarbonate material. Next, an integrated hardware injection mold is debugged, the temperature of a mold cavity is controlled to 80° C.-90° C., the flow rate of cooling water is controlled to 1 m/s-2 m/s, and leakage detection is performed under an air pressure of 0.5 MPa-0.8 MPa to guarantee the sealing performance of the mold. After that, the material is fed into an injection molding machine, the temperatures of three sections of a barrel are sequentially set to 220° C.-240° C., 240° C.-260° C. and 260° C.-280° C., injection molding is performed at a pressure of 80 MPa-120 MPa for 10 s-30 s to complete filling, and then temperature holding and cooling are performed. During cooling, a thin-walled product is cooled for 10 s-20 s, a thick-walled product is cooled for 30 s-60 s, and the temperature of cooling water is 15° C.-25° C. After demolding, sanding and polishing are performed multiple times until the surface roughness reaches Ra0.2-Ra0.4 μm. Finally, the optical properties, waterproofness and anti-aging performance are detected to ensure that the light transmittance is equal to or greater than 88% and no water leaks under the pressure of 10 kPa within 30 min. In this way, the sealing performance of the lens is improved.

### BRIEF DESCRIPTION OF THE SEVERAL VIEWS OF THE DRAWINGS

The contents of the invention are described with reference to accompanying drawings. It should be understood that the accompanying drawings are merely for the purpose of description and are not intended to limit the protection scope of the invention. In the drawings, identical reference signs indicate identical components. Wherein:

FIG. 1 illustrates a schematic overall process flow diagram according to one embodiment of the invention;

FIG. 2 illustrates a schematic process flow diagram according to one embodiment of the invention;

FIG. 3 illustrates a schematic overall structural diagram according to one embodiment of the invention;

FIG. 4 illustrates a schematic overall exploded structural view according to one embodiment of the invention.

In the FIGS.: 1, product body; 11, lens; 12, shell; 13, lamp holder.

### DETAILED DESCRIPTION OF THE INVENTION

It may be easily understood that those ordinarily skilled in the art may propose various interchangeable structures and implementations according to the technical solution of the invention without changing the essential spirit of the invention. Therefore, the following specific embodiments and accompanying drawings are merely used for an illustrative description of the technical solution of the invention and should not be construed as all of the invention or restrictions or limitations of the technical solution of the invention.

### Embodiment 1

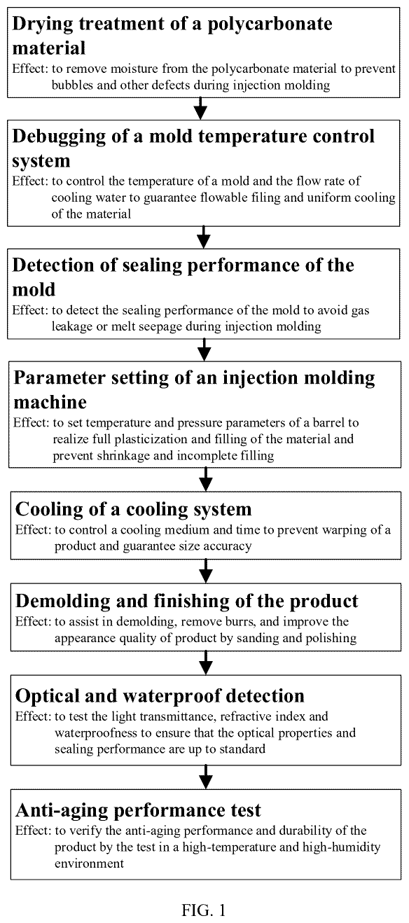

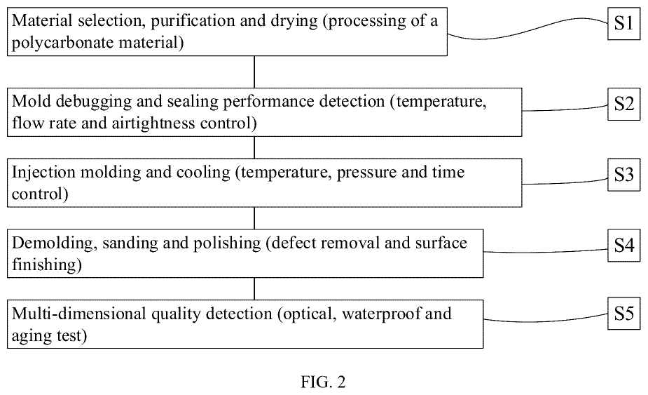

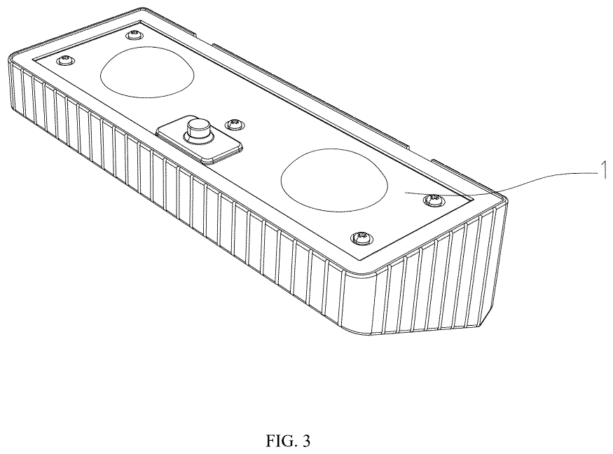

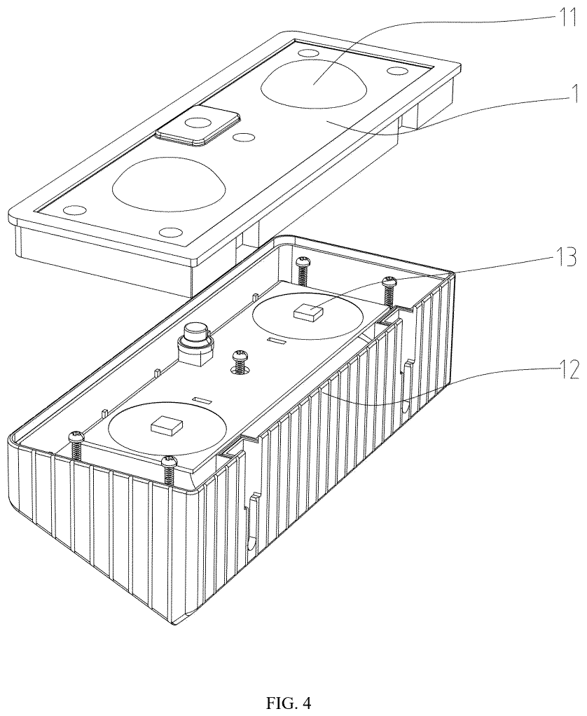

To improve the sealing performance of lenses, as shown in FIGS. 1-4, the following preferred technical solution is provided: an integrated injection-molding method for a lens includes the following steps:
S1, first, a high-transparency polycarbonate material is selected and purified to remove impurities and excess moisture so as to improve material purity to ensure that the high-transparency polycarbonate material satisfies material quality requirements of injection molding;
S2, comprehensive inspection and debugging are performed on a manufactured integrated hardware injection mold, close attention is paid to a mold temperature control system, a mold cooling system and other key components to ensure that all components of the mold are accurately installed and in a good operating condition and satisfy injection-molding process requirements;
S3, the processed polycarbonate material is fed into a barrel of an injection molding machine, and temperature, pressure, time and other parameters of the injection molding machine are controlled to complete filling, compaction and cooling of the material in a mold cavity so as to realize integrated formation of a lens and other structures to guarantee structural compactness and waterproofness of a product body 1;
S4, when the product body 1 is formed gradually, an injection-molded lens product is ejected from the mold, flash, burrs and other defects on surfaces of the lens product are removed, and the lens product is finished by sanding and polishing according to a product quality standard to improve product appearance and surface quality; and
S5, when the product body 1 is taken out, size accuracy, optical properties, waterproofness and structural strength of the lens product are comprehensively detected by means of multiple professional detection methods, and whether the product body 1 is qualified according to the strict quality standard to ensure that the product body 1 flowing into the market has a reliable quality.

In a step of injection molding material processing in S1, the polycarbonate material is placed in a hot-air circulation drying device, the drying temperature is controlled to 120° C.-130° C., and the polycarbonate material is continuously dried for 4-6 hrs until the moisture content of the polycarbonate material is decreased to be less than 0.02%, to avoid bubbles, silver streaks and other defects caused by moisture in the injection molding process. By drying the polycarbonate material at a specific temperature for a specific time by means of the hot-air circulation drying device to a low moisture content, bubbles, silver streaks and other defects caused by moisture are avoided, thus guaranteeing the injection-molding quality of the lens.

In a step of mold debugging before injection molding in S2, the mold temperature control system is accurately controlled to maintain the temperature in the mold cavity at 80° C.-90° C. to guarantee smooth flowing and filling of the material in the mold cavity, and at the same time, the flow rate of cooling water in the mold cooling system is controlled to 1 m/s-2 m/s to guarantee uniform and efficient cooling of the mold. By accurately controlling the mold temperature control system to maintain the temperature in the mold cavity at 80° C.-90° C., the fluidity and filling effect of the material in the mold are guaranteed; meanwhile, by controlling the flow rate of the cooling water in the mold cooling system to 1 m/s-2 m/s, uniform and efficient cooling of the mold is ensured, thus guaranteeing smooth injection-molding and product quality of the lens.

In the step of mold debugging before injection molding in S2, the sealing performance of an overall structure of the mold is detected applying compressed air at a pressure of 0.5 MPa-0.8 MPa into the mold cavity by means of an air pressure leakage-detection device, holding the pressure for 5-10 min and monitoring that a pressure drop is not over 0.05 MPa, or by smearing soapy water at joints of the mold and observing that no bubble is generated within 30 s, to ensure that no gas leaks from the mold in the injection molding process. The overall sealing performance of the mold is guaranteed by air-pressure leakage detection or soapy water detection, such that gas leakage in the mold injection process is prevented, which may otherwise affect the product quality.

In a step of integrated injection-molding in S3, the temperature of a feeding section of the barrel of the injection molding machine is set to 220° C.-240° C., the temperature of a compression section is set to 240° C.-260° C., and the temperature of a metering section is set to 260° C.-280° C., to guarantee full plasticization of the material; and the injection-molding pressure is set to 80 MPa-120 MPa, the injection-molding time is controlled to 10 s-30 s, the holding pressure is set to 60 MPa-90 MPa, and the holding time is controlled 5 s-15 s, to guarantee dense filling of the material in the mold to avoid shrinkage, incomplete filling and other problems of a product. By performing gradient control on the temperatures of the three sections of the barrel of the injection molding machine to realize full plasticization of the material and setting the injection-molding pressure to 80 MPa-120 MPa, the injection-molding time to 10 s-30 s, the holding pressure to 60 MPa-90 MPa and the holding time to 5 s-15 s to guarantee dense filling of the material in the mold, shrinkage, incomplete filling and other problems of the product are avoided.

In the step of integrated injection-molding in S3, the mold cooling system is started instantly after injection-molding filling is completed; the flow rate and temperature of a cooling medium are controlled to realize quick and uniform cooling of the product body 1, wherein the cooling medium is cooling water, and the temperature of the cooling water is maintained at 15° C.-25° C.; in a case where the product body 1 has a small wall thickness, the cooling time is 10 s-20 s; in a case where the product body 1 has a large wall thickness, the cooling time is 30 s-60 s, such that deformation, warping and other defects of the product body 1 caused by nonuniform cooling are avoided to guarantee size accuracy and appearance quality of the product body 1. By using cooling water at the temperature of 15° C.-25° C. as the cooling medium and accurately controlling the cooling time according to the wall thickness of the product, quick and uniform cooling may be realized to prevent deformation, warping and other defects of the product body 1 caused by nonuniform cooling, thus guaranteeing size accuracy and appearance quality.

In a step of post-processing the formed product body 1 in S4, an environmentally-friendly release agent is used for demolding to reduce friction between the product body 1 and the mold so as to ensure that the product body 1 is smoothly ejected from the mold and surfaces of the product body 1 are not damaged; after demolding, the flash and burrs on the surfaces of the product body 1 are removed with a special tool; portions with a high precision requirement are sanded by means of a numerically-controlled sanding device with a sandpaper, the granularity of which sequentially decreases from 80 meshes, 120 meshes, 240 meshes to 400 meshes; and finally, the product body 1 is polished by means of a polishing machine and a polishing paste until surface roughness of the product body 1 reaches Ra0.2-Ra0.4 μm, such that the appearance quality of the product body 1 is improved. The friction between the product and the mold is reduced by means of the environmentally-friendly release agent to ensure that product body 1 is smoothly ejected from the mold and surfaces of the product body 1 are not damaged; after demolding, the flash and burrs are removed by means of the special tool, high-precision portions are sanded by means of the numerically-controlled sanding device with the sandpaper, the granularity of which decreases from 80 meshes to 400 meshes; and finally, the product body 1 is polished by means of the polishing machine and the polishing paste to control the surface roughness of the product body 1 to Ra0.2-Ra0.4 μm, thus significantly improving the appearance quality of the product.

In a step of quality detection and evaluation of the product body 1 in S5, the light transmittance, the refractive index, the chromatic dispersion and other optical properties of the product body 1 are tested by means of an optical tester; as required, the light transmittance is not less than 88% and the refractive index is in line with a design value ±0.002, to ensure that the optical properties of the product body 1 are up to standard; and whether the waterproofness of the product body 1 satisfies use requirements is verified by means of a waterproof test device according to a criterion that no water leaks from the product body 1 after the product body 1 is maintained at a pressure of 10 kPa for 30 min. By quantitatively testing the light transmittance and the refractive index by means of the optical tester and verifying the waterproofness by means of the waterproof test device according to the criterion that no water leaks under the condition that the product body 1 is maintained at the pressure of 10 kPa for 30 min, it is ensured that the optical and waterproof indicators of the product body 1 satisfy use requirements.

In the step of quality detection and evaluation of the product body 1 in S5, an anti-aging performance test is performed on the product body 1; the product body 1 is placed in an environmental test chamber at a temperature of 70° C. and a humidity of 90%, and after the product body 1 is retained in the environmental test chamber for 1000 hrs, changes of optical and mechanical properties of the product body 1 are detected; and whether the product body 1 has good anti-aging performance and durability to adapt to different service environments is verified according to a criterion that a decrease in light transmittance is not over 5% and a decrease in tensile strength is not over 10%. By placing and retaining the product body 1 in the environmental test chamber at the temperature of 70° C. and the humidity of 90% for 1000 hrs, detecting the changes of the optical and mechanical properties of the product and verifying whether the anti-aging performance and durability of the product body 1 according to the criterion that the decrease in light transmittance is not over 5% and the decrease in tensile strength is not over 10%, it is ensured that the product body 1 is able to adapt to various complex service environments.

A lens 11 is fixedly mounted in the product body 1, a shell 12 is arranged on a lower surface of the product body 1, a lamp holder 13 is fixedly mounted in the shell 12, and the lamp holder 13 and the lens 11 are located on a same vertical line. The product body 1 and the lens 11 are integrated by integrated injection-molding, and seamless connection of the integrated lens is realized, such that the waterproofness is good, and water vapor is effectively prevented from entering the lens 11; in addition, the integrated lens is spaced apart from LED lamp beads by a safe distance, such that the LED lamp beads are accurately prevented from being squeezed and comprehensively protected from being damaged by external force, thus guaranteeing stable operation of optical modules and lighting elements.

Specifically, when the lens 11 is produced, a high-transparency polycarbonate material is selected and placed in the hot-air circulation drying device to be dried at a temperature of 120° C.-130° C. for 4-6 hrs until the moisture content of the polycarbonate material is less than 0.02%, to remove impurities and moisture; next, the integrated hardware injection mold is inspected and debugged, the temperature control system is controlled to maintain the temperature in the mold cavity at 80° C.-90° C., the flow rate of water in the cooling system is controlled to 1 m/s-2 m/s, and the sealing performance of the mold is ensured by air-pressure leakage detection (compressed air at a pressure of 0.5 MPa-0.8 MPa is applied into the mold, the pressure is held for 5-10 min, and the pressure drop is equal to or less than 0.05 MPa)) or by smearing soapy water at joints (no bubble is generated within 30 s); after that, the processed material is fed into the barrel of the injection molding machine, the temperature of the feeding section, the temperature of the compression section and the temperature of the metering section are controlled to 220° C.-240° C., 240° C.-260° C. and 260° C.-280° C. respectively to realize full plasticization of the material, injection molding is performed at a pressure of 80 MPa-120 MPa for 10 s-30 s to realize filling of the material in the mold cavity, and then the pressure is held at 60 MPa-90 MPa for 5 s-15 s; the cooling system is started instantly after filling is completed, cooling water at a temperature of 15° C.-25° C. is adopted, and the cooling time is controlled according to the wall thickness (10 s-20 s for a small wall thickness, 30 s-60 s for a large wall thickness) to realize integrated formation of the lens and the product body 1 to guarantee the structural compactness and waterproofness; during demolding, an environmentally-friendly release agent is used to reduce the friction, and after demolding, flash and burrs are removed by means of a special tool; high-precision portions are sanded by means of the numerically-controlled sanding device with a sandpaper, the granularity of which decreases from 80 meshes, 120 meshes, 240 meshes to 400 meshes; and then, the product body 1 is polished by means of the polishing machine and the polishing paste until the surface roughness of the product body 1 reaches Ra0.2-Ra0.4 μm; and finally, the light transmittance (≥88%), the refractive index (design value: ±0.002) and other optical properties are tested by means of an optical tester, the pressure is held at 10 kPa for 30 min to verify, by means of the waterproof test device, that no water seepage occurs, the product body 1 is placed and aged in the environmental test chamber at a temperature of 70° C. and a humidity of 90% for 1000 hrs, and the decrease in light transmittance (≤5%) and the decrease in tensile strength (≤10%) are detected to ensure that the optical properties, waterproofness and anti-aging performance of the lens 11 are up to standard, thus improving the sealing performance of the lens.

The above embodiment is merely a preferred specific one of the invention, and the protection scope of the invention is not limited to the above embodiment. All equivalent substitutions or transformations made by any skilled in the art according to the technical solution and inventive concept of the invention without departing from the technical scope disclosed by the invention should also fall within the protection scope of the invention.

What is claimed is:

1. An integrated injection-molding method for a lens, comprising the following steps:
S1: first, selecting a high-transparency polycarbonate material, and purifying the high-transparency polycarbonate material to remove impurities and excess moisture so as to improve material purity to ensure that the high-transparency polycarbonate material satisfies material quality requirements of injection molding;
S2: performing comprehensive inspection and debugging on a manufactured integrated hardware injection mold, and paying close attention to a mold temperature control system and a mold cooling system to ensure that all components of the mold are installed accurately and in a good operating condition and satisfy injection-molding process requirements;
S3, feeding the processed polycarbonate material into a barrel of an injection molding machine, and controlling temperature, pressure and time parameters of the injection molding machine to complete filling, compaction and cooling of the material in a mold cavity so as to realize integrated formation of a lens and other structures to guarantee structural compactness and waterproofness of a product body;
S4: when the product body is formed gradually, ejecting an injection-molded lens product from the mold, removing flash and burrs and other defects on surfaces of the lens product, and finishing the lens product by sanding and polishing according to a product quality standard to improve product appearance and surface quality; and
S5, when the product body is taken out, comprehensively detecting size accuracy, optical properties, waterproofness and structural strength of the lens product by means of multiple professional detection methods, and determining whether the product body is qualified according to the strict quality standard to ensure that the product body flowing into the market has a reliable quality.

2. The integrated injection-molding method for a lens according to claim 1, wherein in a step of injection molding material processing in S1, the polycarbonate material is placed in a hot-air circulation drying device, a drying temperature is controlled to 120° C.-130° C., and the polycarbonate material is continuously dried for 4-6 hrs until a moisture content of the polycarbonate material is decreased to be less than 0.02%, to avoid bubbles and silver streaks caused by moisture in the injection molding process.

3. The integrated injection-molding method for a lens according to claim 1, wherein in a step of mold debugging before injection molding in S2, the mold temperature control system is accurately controlled to maintain a temperature in the mold cavity at 80° C.-90° C. to guarantee smooth flowing and filling of the material in the mold cavity, and at the same time, a flow rate of cooling water in the mold cooling system is controlled to 1 m/s-2 m/s to guarantee uniform and efficient cooling of the mold.

4. The integrated injection-molding method for a lens according to claim 1, wherein in a step of mold debugging before injection molding in S2, sealing performance of an overall structure of the mold is detected by applying compressed air at a pressure of 0.5 MPa-0.8 MPa into the mold cavity by means of an air pressure leakage-detection device, holding the pressure for 5-10 min and monitoring that a pressure drop is not over 0.05 MPa, or by smearing soapy water at joints of the mold and observing that no bubble is generated within 30 s, to ensure that no gas leaks from the mold in the injection molding process.

5. The integrated injection-molding method for a lens according to claim 1, wherein in a step of integrated injection-molding in S3, a temperature of a feeding section of the barrel of the injection molding machine is set to 220° C.-240° C., a temperature of a compression section is set to 240° C.-260° C., and a temperature of a metering section is set to 260° C.-280° C., to guarantee full plasticization of the material; and an injection-molding pressure is set to 80 MPa-120 MPa, an injection-molding time is controlled to 10 s-30 s, a holding pressure is set to 60 MPa-90 MPa, and a holding time is controlled 5 s-15 s, to guarantee dense filling of the material in the mold to avoid shrinkage and incomplete filling of a product.

6. The integrated injection-molding method for a lens according to claim 1, wherein in a step of integrated injection-molding in S3, the mold cooling system is started instantly after injection-molding filling is completed; a flow rate and temperature of a cooling medium are controlled to realize quick and uniform cooling of the product body, wherein the cooling medium is cooling water, and the temperature of the cooling water is maintained at 15° C.-25° C.; in a case where the product body has a small wall thickness, a cooling time is 10 s-20 s; in a case where the product body has a large wall thickness, the cooling time is 30 s-60 s, such that deformation and warping of the product body caused by nonuniform cooling are avoided to guarantee size accuracy and appearance quality of the product body.

7. The integrated injection-molding method for a lens according to claim 1, wherein in a step of post-processing the formed product body in S4, an environmentally-friendly release agent is used for demolding to reduce friction between the product body and the mold so as to ensure that the product body is smoothly ejected from the mold and surfaces of the product body are not damaged; after demolding, the flash and burrs on the surfaces of the product body are removed with a special tool; portions with a high precision requirement are sanded by means of a numerically-controlled sanding device with a sandpaper, a granularity of which sequentially decreases from 80 meshes, 120 meshes, 240 meshes to 400 meshes; and finally, the product body is polished by means of a polishing machine and a polishing paste until surface roughness of the product body reaches Ra0.2-Ra0.4 μm, such that the appearance quality of the product body is improved.

8. The integrated injection-molding method for a lens according to claim 1, wherein in a step of quality detection and evaluation of the product body in S5, a light transmittance, a refractive index and a chromatic dispersion of the product body are tested by means of an optical tester; as required, the light transmittance is not less than 88% and the refractive index is in line with a design value ±0.002, to ensure that the optical properties of the product body are up to standard; and whether the waterproofness of the product body satisfies use requirements is verified by means of a waterproof test device according to a criterion that no water leaks from the product body after the product body is maintained at a pressure of 10 kPa for 30 min.

9. The integrated injection-molding method for a lens according to claim 1, wherein in a step of quality detection and evaluation of the product body in S5, an anti-aging performance test is performed on the product body; the product body is placed in an environmental test chamber at a temperature of 70° C. and a humidity of 90%, and after the product body is retained in the environmental test chamber for 1000 hrs, changes of optical and mechanical properties of the product body are detected; and whether the product body has good anti-aging performance and durability to adapt to different service environments is verified according to a criterion that a decrease in light transmittance is not over 5% and a decrease in tensile strength is not over 10%.

10. A lens formed by the integrated injection-molding method for a lens according to claim 9, wherein the lens is fixedly mounted in the product body, a shell is arranged on a lower surface of the product body, a lamp holder is fixedly mounted in the shell, and the lamp holder and the lens are located on a same vertical line.
